(19) United States
(12) Patent Application Publication
(10) Pub. No.: US 2007/0082815 A1
(43) Pub. Date: Apr. 12, 2007

(54) Grease and oil absorbent

(76) Inventor: Anund Pihstrom, Hudiksvall (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/591,764

(22) PCT Filed: Feb. 3, 2005
(86) PCT No.: PCT/SE05/00142

§ 371 Date: Oct. 17, 2006

(30) Foreign Application Priority Data
Feb. 3, 2004 (SE) 0400246-5

(51) Int. Cl. B01J 20/22

(52) U.S. Cl. 502/401

(57) ABSTRACT

This invention relates to a biological substance (oil absorbent) for the absorption of grease and oil. The invention is preferably used for removal of heavy oil released from ships and moreover oils, which are spilled out upon workshop floors. The invention utilizes byproducts and residual products such as bark, branches and sawdust as raw materials. The oil absorbent contains a vital component with a thin shape. The component's length is at least ten times greater than its width and its proportion makes up at least ten percent of the absorbent's total weight. Ingredients in this compound include among others Bornyl acetate, cadinene and limonene. For dispersal of the absorbent an ejector system is used together with a nozzle. This apparatus makes it possible to disperse the absorbent in different directions.

### TECHNICAL FIELD

This invention relates to a biological substance for the absorption of grease and oil. The invention is especially suited for removal of heavy-oil released from ships and moreover oils, which are spilled out upon workshop floors. The invention utilizes byproducts and residual products as raw materials signifying the invention's importance in society's endeavor to forge a better environment through efficient use of natural resources.

### BACKGROUND ART

Different methods for decontamination of water and surface areas as well as buildings, which have been contaminated by oil spills or discharges of other oil-based products, have been developed. Thus, a certain kind of technique is utilized for decontamination of partially volatile products while another kind of technique is normally used for high viscose oils or grease. Climate also influences the choice of method.

When oil leaks out (or after deliberate draining) considerable efforts are required for collection and clean up of everything soiled by the oil. A first method for stopping further spreading of oil is often comprised of the placement of specially designed booms, which become a type of floating wall around the spill. Winter weather conditions may cause problems with the use of booms. Consequently, booms may lose their ability to float and remain stable because of icing.

The described containment of oil is often combined with the addition of an absorbent, which with varying results absorbs the oil. With the assistance of different devices, everything from hand tools to apparatus placed on specially built boats and vehicles, most of the oil is collected. Oil soaked material is treated with oil solvents or oil emulsifying chemicals. This treatment is often performed in combination with water or steam jets. The drawback with this type of treatment is the difficulty of recovering the oil and the risk that additives will in turn further pollute the environment. Since oil is biodegradable over the long run, spraying oil-degrading microorganisms over oil-contaminated areas does occur.

Different kinds of embankments along the seashore are erected to stop the oil's encroach upon beaches. Besides damage to the water and upon beaches, many animal species and in particular birds are harmed. Damage of another kind occurs in factory or workshop environments. A small oil slick can easily cause people to slip and fall. Broken limbs and concussions are common injuries.

### DISCLOSURE OF THE INVENTION

With the aid of the present invention it will be possible to dramatically reduce problems that today afflict known materials and methods.

A distinguishing feature of the invention is that byproducts and residual products such as bark and branches are mixed with specific active ingredients. Examples of such ingredients include among others Bornyl acetate, dipentene, limonene, pinene sylvestrene and cadinene. In certain cases the product can be augmented by materials such as peat and residual lignin, which are acquired after acid hydrolysis of wood. Fiber sludge and/or biosludge from the forest industry as well as sludge from municipal sewage treatment facilities can also be used. Yet another variation comprises additives of ground wood materials such as sawdust, wood chips and branches. The respective proportions of each additive/residual product may vary within a large interval. The principal component is however, bark which is preferably ground and thereafter sifted to achieve optimal particle size.

In order to regulate the product's pH, sodium silicate (water glass) can be added, thereby enabling the pH to be adjusted within an interval from 5 to 10 and preferably from 6 to 8. It is also possible to use calcium compounds to regulate the pH. In exceptional cases caustic soda may be used. Residual products such as biofuel ash, green lye sludge and chalk (calcium carbonate) can also be utilized for adjusting the pH.

It is important that the mixture of comprised ingredients is homogeneous. This is attained by mechanically processing the mixture in the appropriate apparatus. In conjunction with this process for the homogenization of the product, it could be appropriate to infuse heat in order to expel any excess water. If needed the mixture can be dried to achieve a moisture content of less than 30 percent by weight and preferably less than 15 percent. Conversely, according to the invention the components can be dried before mixing (homogenizing).

The present product produced in accordance with the invention is designated hereafter as the oil absorbent or only the absorbent. The absorbent has after drying or at a dry matter content of 70-95 percent and in loose form a density of 250-350 kilograms per cubic meter. The oil absorbent can by means of pressing be compressed to a density of over 550 kilograms per cubic meter, which can be maintained by for example a shrink pack.

In addition to this, the invention is characterized by a component added to the oil absorbent having a very thin configuration. In accordance with the invention, the relationship between length and breadth should be at least 10 to 1 (10:1), that is to say the length should always be at least 10 times greater than the components breadth. A ratio of at least 20:1 is preferable. This component can be comprised of wood sawdust, shavings from birch bark, conifer needles and grasses. Conifer needles from the wood species commonly known as pine are preferred. Even fibers derived from cellulose derivates (viscose fiber) can be used. In order to retain desired stiffness the fiber length ought not exceed 6 mm. The weight proportion of the specific thin particles must amount to at least 10 percent and preferably at least 20 weight percent calculated on the oil absorbents total weight.

The absorbent may be packed in bags or sacks that form pillows. The pillows can preferably be used as an oil collector under motors and on previously oil soiled surfaces. The material in the encapsulating cover can be comprised of synthetic fabric or consist of non-woven fabric. A significant feature of the fabric is that it is permeable, that is to say that air, water and oil may pass through the fabric without significant resistance. This fabric may be manufactured of fibers from raw materials such as polypropene, polyetene and polyamide or from regenerated dissolving pulp. The pillows can be produced automatically or semi-automatically from prefabricated fibers and can preferably be packaged in so called shrink packs with a protective layer of plastic foil. Due to the fact that the pillow manufactured in accordance with the invention is compressible, the packaging can hold relatively many pillows. The pillows can even be supplied in other forms and then packed in two or more different formats which form bale-like units. Preferably, each such unit should then have an appropriate covering that upholds reasonable demands on strength, resistance to moisture and temperature variations. Both the pillows and the packaging must consist of materials, which do not have harmful effects on either the working environment or the natural environment.

The oil absorbent can through fractionation (sifting) of the comprising raw materials (bark, branches, peat, etc.) be manufactured with particles which size can vary within a relatively large interval. A distinguishing characteristic of the invention is that the absorbent contains particles that pass through sifts where diagonal mesh size measures 20 mm. If an oil absorbent with a particle size of 2-10 mm is desired, another sift can be used with an appropriate mesh size.

Since the oil absorbent has a low density and occasionally must be spread over a relatively large area, sometimes even under severe weather conditions, it is very difficult, maybe even impossible to conduct meaningful clean-up efforts. Because of this, a procedure concerning the dispersal of the absorbent, within the constraints of the invention is included.

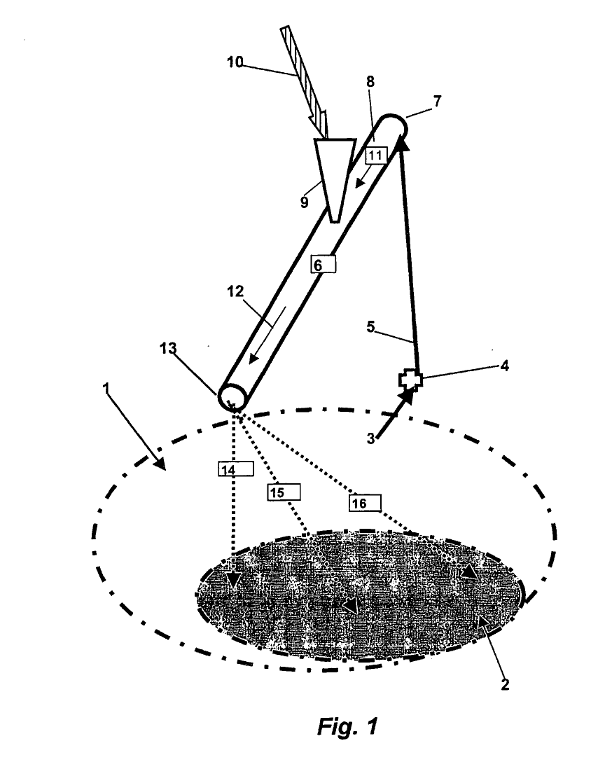

With the aid of FIG. 1 the preferable design for the invention will be described. The oval 1 represents a surface of water in which one part 2 is covered by an oil spill. By way of the pipe 3, the pump 4 and the pipe 5 water at a pressure of at least 3 kg/cm² is supplied to an ejector's 6 one and sealed end of a conveyor pipe 8. On the water conveyor pipe an input funnel is placed, which in principle may be positioned anywhere along the pipe, for infusion of the oil absorbent 10, which is then mixed by the rapidly moving water, marked in the FIGURE by the arrows 11, 12. A nozzle (not shown in the FIGURE) can be coupled to the conveyor pipe's discharging end 13, which will allow the dispersal of the mixture of water and absorbent in many different directions such as sideways and up and down. FIG. 1 demonstrates three choices of sideways direction 14, 15 and 16. Within the constraints of the invention, a hose may be coupled to the conveyor pipe, which in some cases may allow for a more exact dispersal of the oil absorbent, which in turn can reduce the amount of absorbent needed.

### DESIGN EXAMPLE 1

A tub of water contaminated with oil and paper was used for this test. On the surface a 2 cm thick layer of the oil absorbent was applied. In order to achieve maximum contact with the oil, the entire content of the tub was stirred with a wooden stick. Surprisingly this resulted in an almost instantaneous absorption of the oil, which together with the absorbent formed a viscous mixture. Very surprisingly the mixture could with ease be scooped up with the use of only the hands. Noteworthy is the fact that the hands were practically clean after the removal of the oil intermixed with the absorbent from the tub.

### DESIGN EXAMPLE 2

Onto a checkered plate (1×1 m) was poured 1 liter of waste oil from an internal combustion engine. During this test 2 liters of the oil absorbent were spread over the spilled oil. In other words a volume of absorbent twice the volume of the waste oil was applied. In regards to weight the amount of absorbent was approximately 60 percent that of the amount of waste oil. Even in this case a quick absorption of the oil was attained. Particularly surprising was that after all the waste oil and absorbent hade been removed from the plate, it could be established that the checkered plate was in closest respects clinically free from waste oil.

### DESIGN EXAMPLE 3

In a bay approximately 10 meters from the shoreline 100 liters of motor oil was poured into the seawater. The shoreline is chiefly comprised of fill containing boulders and sand. The wind strength during the test was between 5 and 7 meters per second. Air temperature registered at 8 degrees Centigrade and water temperature measured in at 6 degrees Centigrade.

The oil was dispersed under controlled circumstances onto an area of approximately 200 square meters. By aid of the procedure in accordance with the invention, 150 liters (dm³) of oil absorbent were dispersed over the oil slick on the surface of the water. In addition approximately 70 dm³ of the oil absorbent were spread out along the shoreline. After approximately two minutes the absorbent and the oil were already melding into an agglomerate. An important advantage of the invention was noted when the lumps (agglomerate) floated on the surface of the water and could therefore be easily collected from the coastline when the agglomerate floated ashore with the help of the wind. After the test no oil could be detected on the surface of the water, and even more surprising was the fact that both sand and boulders along the shore were also free of oil.

### DESIGN EXAMPLE 4

The oil and the absorbent from the describe tests were mixed together and then set afire. The mixture burned easily and the invention can therefore also be used as a fuel with a high-energy value.

### ADVANTAGES OF THE INVENTION

Of essential importance to the environment is the fact that the oil absorbent contains natural ingredients such as bark and peat, which in turn makes the absorbent biodegradable. The difference between this invention and other inventions is that the oil and the absorbent do not sink but instead float on the surface of the water. Another advantage with the invention is that it is burnable and together with the oil it can form a fuel with a high-energy value.

In addition, the present invention needs no new machinery units in order to utilize the procedure for decontamination. Thus a significant economic advantage is achieved by exploiting the present invention, which includes both the product and the procedure.

1. A grease and oil absorbent containing among other ingredients ground and sifted bark characterized in that the oil absorbent is comprised of conifer needles containing elements of bornyl acetate, cadinene and limonene in which the needles have a thin shape where there length is at least ten times greater than there width.

2. A grease and oil absorbent according to claim 1 characterized in that the oil absorbent contains conifer needles preferably from the wood species known as pine.

3. A grease and oil absorbent according to claim 1 and claim 2 characterized in that the oil absorbent is comprised of conifer needles that make up at least ten percent of the absorbent's total weight.

4. A grease and oil absorbent according to claim 1 and claim 2 characterized in that the absorbent contains ground and/or shredded branches, sawdust or ground reed canary-grass and or straw.

5. A grease and oil absorbent according to one or more of claims 1-3 characterized in that the absorbent contains lignin obtained from acid hydrolysis of wood.

6. A grease and oil absorbent according to one or more of claims 1-4 characterized in that the absorbent contains fiber sludge from the forest industry.

7. A grease and oil absorbent according to claims 1-5 characterized in that the absorbent contains particles that pass through sifts where the diagonal mesh size measures 20 mm.

8. A grease and oil absorbent according to one or more of claims 1-6 characterized in that the absorbent's acidity lies within a pH-range from 5 to 10 and preferably from 6 to 8.
